(19) United States
(12) Patent Application Publication
(10) Pub. No.: US 2004/0122920 A1
(43) Pub. Date: Jun. 24, 2004

(54) System for controlling processes associated with streams within a communication network

(75) Inventors: Sebastien Josset, Toulouse (FR); Stephane Combes, Toulouse (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/716,465

(22) Filed: Nov. 20, 2003

(30) Foreign Application Priority Data
Dec. 20, 2002 (FR) 02 16 339

(51) Int. Cl. G06F 15/177; G06F 15/173

(52) U.S. Cl. 709/222; 709/224

(57) ABSTRACT

A system is dedicated to controlling processes associated with streams of application data for a communication network including communication stations adapted to exchange data streams and connected to communication terminals provided with at least one application and one core containing information representative of the applications. The system includes processing arrangements which, on receiving a message designating an application, deliver service data representative of at least one process associated with the designated application. The system also includes extraction arrangements which, on receiving a stream of data sent by a communication terminal, access the core of the terminal to determine the application associated with the received stream and then deliver to the processing means a message designating the determined application. The system further includes control arrangements which, on receiving service data delivered by the processing means, deliver configuration data adapted to enable at least one process suited to the requirements of the application associated with the received stream by the communication station to which the terminal from which the stream came is connected.

### CROSS-REFERENCE TO RELATED APPLICATIONS

This application is based on French Patent Application No. 02 1 6 339 filed Dec. 20, 2002, the disclosure of which is hereby incorporated by reference thereto in its entirety, and the priority of which is hereby claimed under 35 U.S.C. §119.

### BACKGROUND OF THE INVENTION

1. Field of the invention

The field of the invention is that of communication between terminals of a communication network, and more particularly that of managing processes, for example quality of service and security processes, associated with application data exchanged between terminals.

2. Description of the prior art

In the present context, “terminal” refers to any network equipment and in particular any user equipment, such as a fixed or mobile computer, a landline or mobile telephone, a router or a server.

Many data processing applications, for example Voice over IP (VoIP), MultiMedia over IP (MMoIP) and File Transfer Protocol (FTP) applications, require one or more processes to operate, for example a certain quality of service (QoS) level and/or a certain security level (authentication and/or encryption). For example, in a satellite or wireless network it is usually the communication stations that are responsible for associating a quality of service and/or a level of security with data of a chosen application, that they have received from a source terminal and is addressed to a destination terminal.

To establish this kind of association, a communication station, for example a satellite terminal, has only information contained in the data received. For example, in the case of IP data packets, the communication station has source and destination IP addresses, source and destination ports, and possibly a marking, for example a Diffserv marking.

As the person skilled in the art knows, the source and destination IP addresses identify only the terminals, or possibly a network, but never an application.

What is more, a small number of ports are recommended for certain applications, for example port 25 for electronic mail (e-mail) and port 80 for the Internet (Web), but the allocation resulting from such recommendations is generally effected dynamically or negotiated via a control channel (for example FTP, H323, or SIP). Although it is not possible to eavesdrop on the control channel by tracing connections (which necessitates a knowledge of the protocol specific to each application, which is often encrypted), it is impossible to determine the application concerned.

In an attempt to improve the situation, it has been proposed to provide certain applications with means enabling them to specify either their requirements in terms of quality of service or their traffic type. However, specifying the quality of service requires the use of the protocol known as RSVP, a network of routers supporting RSVP, and specific libraries, with the result that it is hardly ever done.

Moreover, the traffic type can be specified by using the Diffserv protocol, whose implementation is relatively simple but which is very little used in practice and does not guarantee homogeneous processing.

To enable secure transport of IP data, a byte mixing algorithm known as the scrambling DVB-RCS algorithm has been proposed for securing level 2 of the ISO model and the IP Sec protocol in point-to-point (unicast) connection mode or point-to-multipoint (multicast) connection mode has been proposed for securing the IP level 3 of the ISO model. However, the streams of IP data to be encrypted must be configured statically as a function of associated source and destination addresses, and security between two terminals of a network or between two networks is on an “all or nothing” basis.

Furthermore, to provide quality of service (QoS) support, it has been proposed to use predetermined QoS profiles associated with each terminal, to use manual configuration, or to set up dynamic calls between the application concerned and the satellite network's central server, which is known as the network control center (NCC). However, in the first situation, it is very difficult to differentiate dynamically real time and standard (best-effort) IP streams, in the second situation the correspondence between the different IP stream types and the associated QoS must be established manually, as a function of certain source and destination addresses, and in the third situation the applications must be modified so that they can interact with the NCC, although most of them are not easy to modify.

As a result most applications make do with the QoS and/or the security level configured statically for their host.

An object of the invention is therefore to remedy some or all of the drawbacks previously cited.

### SUMMARY OF THE INVENTION

To this end, the invention proposes a system for controlling processes associated with streams of application data for a communication network including communication stations adapted to exchange data streams and connected to communication terminals provided with at least one application and one core containing information representative of the applications, which system includes: i) processing means adapted, on receiving a message designating an application, to deliver service data representative of at least one process associated with the designated application, ii) extraction means adapted, on receiving a stream of data sent by a communication terminal, to access the core of the terminal to determine the application associated with the received stream and then to deliver to the processing means a message designating the determined application, and iii) control means adapted, on receiving service data delivered by the processing means, to deliver configuration data adapted to enable at least one process suited to the requirements of the application associated with the received stream by the communication station to which the terminal from which the stream came is connected.

Each communication terminal of the network is preferably equipped with extraction means and processing means and each communication station is preferably equipped with control means. The control means of the stations can operate autonomously or in a distributed manner. In the latter case, they deliver their configuration data on receiving an authorization (confirmation) delivered by a central server, such as a bandwidth broker or a network control center (NCC), or a key server for distributing keys for securing links or connections.

The control system according to the invention can have further, complementary features, and in particular, separately and/or in combination:

each communication terminal core includes an interface for real time control of the network streams associated with said applications and said extraction means are adapted, on receiving a data stream, to access said control interface to determine the application associated with said received stream;

memory means adapted to store a table of correspondences between the applications and the service data, in which case the processing means are adapted, on receiving a message designating an application, to access the memory means to determine service data stored in correspondence with the designated application; moreover, if there is no service data stored in the memory means corresponding to a designated application, the processing means are preferably adapted to send a user a message prompting him to supply the service data associated with the designated application via the graphical interface of the communication terminal in which the extraction means are installed;

extraction means adapted to update the correspondence table as a function of information received, for example, in the form of a configuration file or a graphical interface of the communication terminal in which the extraction means are installed;

extraction means preferably installed in one of the protocol stacks of the core of each communication terminal;

when each communication station has at least one protocol stack arranged in layers, including an MAC layer, the control means are adapted, on receiving service data, to deliver configuration data for configuring the MAC layer as a function of the requirements associated with a stream to be transmitted or received;

processing means adapted to deliver to the control means service data representative of at least one process associated with streams to be received from an application installed in a remote communication terminal;

processing means and control means adapted to exchange service messages containing the service data in accordance with an exchange protocol chosen from among a proprietary protocol, the SNMP, the XML protocol, and the RSVP.

The invention also proposes, firstly, a communication terminal including extraction means and processing means of a system of the type described hereinabove, secondly, a communication terminal comprising a system of the type described above, thirdly, a communication station, for example a satellite terminal, including control means of a system of the type described above, and, fourthly, a communication network including the above terminals and/or the above communication stations and preferably chosen from satellite networks and wireless networks.

Other features and advantages of the invention will become apparent on reading the following detailed description and examining the appended drawings.

### BRIEF DESCRIPTION OF THE DRAWINGS

FIG. 1 shows diagrammatically a portion of a communication network equipped with control systems according to the invention.

FIG. 2 is a timing diagram showing diagrammatically one example of the use of the RSVP for securing a satellite link.

### DETAILED DESCRIPTION OF THE PREFERRED EMBODIMENT

The appended drawings constitute not only part of the description of the invention but also, where necessary, contribute to the definition of the invention.

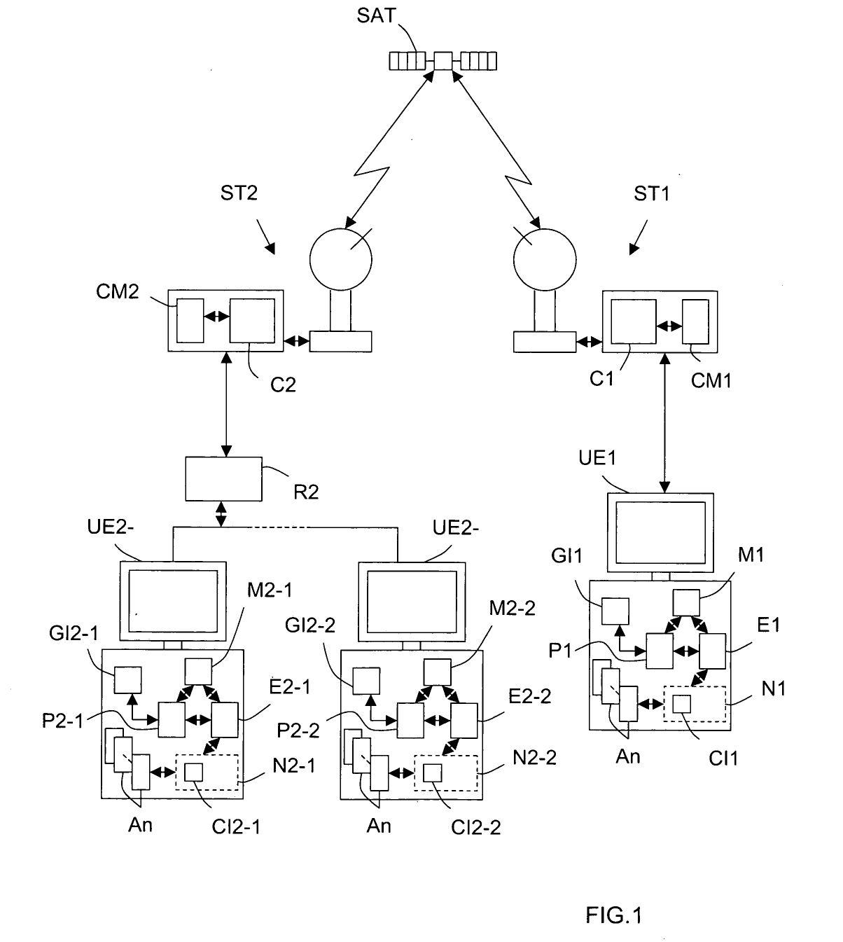

A satellite communication network equipped with a system according to the invention is described first and by way of illustrative example with reference to FIG. 1. The invention is not limited to this type of network, of course. In fact, it relates to all types of network capable of applying at least one process to the streams of data (for example quality of service (QoS), priority, security, filtering and like processes), and especially wireless networks, for example wireless local area networks (WLAN), wireless local loops, and microwave broadcast ports.

The satellite communication network shown very diagrammatically includes a multiplicity of communication stations STi (here i=1 and 2, but i can take any other value greater than 2), connected to communication terminals UEi-k (here i=1 and 2 and k=1 and 2, but i and k can take any other value greater than or less than 2) and interconnected by at least one communication satellite SAT.

It is important to note that a communication terminal UEi and a communication station STi can be combined in one and the same equipment. This can be the case in particular if the communication station takes the form of a PCI card plugged into a PC-based communication terminal.

In the example shown, the communication terminals are user equipments UE1 and UE2-k, such as fixed or mobile computers. However, they could be any type of communication terminal capable of exchanging data with other network equipments or terminals, for example mobile or landline telephones, facsimile machines, personal digital assistants (PDA), and application service providers (ASP).

Moreover, the user equipments UE2-k are here connected to a router R2 of a private network such as a local area network (LAN).

Of course, the communication terminals UE2-k need not be connected to a private or public network of any type. In fact, like the communication terminal UE1, they can be connected to one of the communication stations STi of the network, either directly, for example by a bus, or indirectly, for example via a hub. However, in this case, they must be adapted to exchange information.

Furthermore, it is considered hereinafter that the communication stations STi are satellite terminals adapted to exchange data frames (for example of IP level three) encapsulated in accordance with the Ethernet level two transmission protocol. However, the invention is not limited to a level two transmission protocol according to the ISO model, of course. It relates to all transmission protocols, and in particular the 802.4, 802.5 and 802.11 protocols. As a general rule, the invention relates more particularly to level two (2) and three (3) protocols, but it relates equally to protocols of other levels and in particular those of level one (1) (physical layer) and level seven (7) (application layer).

Each satellite terminal STi includes a communication module Ci responsible, firstly, for determining how to route frames to their destinations using a routing table that is usually learned and, secondly, for transmitting the frames to the air and wire interfaces of the satellite network. The routing function is also known as the bridge function because, being responsible for processing only the Ethernet transmission protocol, it merely switches traffic as a function of physical Internet addresses contained in the frame. The communication module Ci is well known to the person skilled in the art and is not described in detail here. Suffice to say that it is defined by the IEEE 802.1d standard.

Moreover, each user equipment UEi here includes an operating system or core Ni-k having at least one protocol stack and one or more applications An for delivering data of different types. For example, one of the applications is of the Voice over IP (VoIP) type. However, any other type of application can be installed in a communication terminal UEi, and in particular MultiMedia over IP, electronic mail (usually associated with port 25), and Internet access (usually associated with port 80).

Each user equipment UEi preferably further includes an interface Cli-k dedicated to real time control of the network streams associated with applications and a graphical interface Gli-k, for example a graphical user interface (GUI).

The stream control interface Cli-k is a firewall, for example, such as the Microsoft interface or the Linux “ipchain”. This type of interface has been developed to enable a user to choose the process to be applied to an IP stream using a window that opens dynamically, and in particular the following processes: authorization to access a satellite network, allocation of a quality of service, security (authentication and/or encryption), session set-up, and association with error corrector codes.

The invention proposes a system dedicated to control of processes, for example quality of service (QoS) and security processes, associated with data streams coming from applications installed in the user equipments UEi.

The control system includes, firstly, processing means Pi-k responsible for delivering service data representative of at least one process associated with a designated application, secondly, extraction means Ei-k responsible for access to the core Ni-k of a user equipment UEi-k that has sent a data stream in order to determine the application associated with that stream and then to deliver to the processing means Pi-k a message designating the application so determined, and control means CMi responsible, on receiving service data delivered by the processing means Pi-k, for delivering configuration data enabling at least processing suited to the requirements of the application associated with the received stream by the satellite terminal STi to which the user equipment UEi-k from which the stream comes is connected.

Hereinafter, and by way of illustration, the process associated with an application relates to quality of service (QoS) and/or security.

As shown in FIG. 1, the processing means and the extraction means of each control system are preferably distributed in the form of processing modules Pi-k and extraction modules Ei-k in each user equipment UEi-k that said system controls. Moreover, the control means of each system preferably take the form of a control module CMi installed in each communication station STi. Accordingly, in the example shown, the satellite network includes two control systems. The first system includes the control module CM1 installed in the satellite terminal ST1 and the extraction module E1 and the processing module P1 installed in the user equipment UE1. The second system includes the control module CM2 installed in the satellite terminal ST2 and the extraction modules E2-1 and E2-2 and the processing modules P2-1 and P2-2 installed in the user equipments UE2-1 and UE2-2.

However, installing a control system in each user equipment UEI-k or in each communication station STi could be envisaged.

In practice, each extraction module Ei-k observes all the data streams entering and leaving the equipment UEi-k in which it is installed. To this end, the extraction module Ei-k is preferably installed in the protocol stacks of the core Ni-k. It can in particular be a hook or a driver.

Moreover, each extraction module Ei-k preferably determines the application An that is associated with a stream by way of the control interface Cli-k.

To each IP packet there in fact corresponds a socket that is open in an equipment UEi-k identifiable by its port number. The correspondence between the port, the socket and the identifier of the application is available by way of functions provided by the operating system Ni-k of the equipment UEi-k.

For example, in the case of the Windows XP operating system, the

“AllocateAndGetTcpExTableFromStack( )” function of the DLL iphipapi can be used. Similarly, in the case of the Linux operating system, the read function of the file “/proc/xx/fd” can be used.

Each extraction module Ei-k preferably holds an up-to-date table listing the correspondences between the stream identifiers and the application identifiers, on the basis of information that it obtains in the core Ni-k when it accesses the control interface Cli-k. This con enable it to determine more quickly the application that is associated with a stream that it has just detected and whose type it has just identified.

As previously indicated, when an extraction module Ei-k has determined the application associated with a stream, it sends the processing module Pi-k to which it is connected a message designating the application it has determined, so that it can in turn determine service data (the context) representative of the quality of service and/or level of security associated with the application.

To determine the service data associated with the application designated in a received message, the processing module Pi-k preferably consults a context table listing the correspondences between the applications listed within the user equipment UEi-k and the service data. This table is preferably stored in a memory Mi-k of the user equipment UEi-k concerned.

Moreover, each context table is preferably kept up-to-date by each extraction module Ei-k on the basis of data supplied by the user of the equipment UEi-k either in the form of a configuration file or via the graphical interface Gli-k of the equipment UEi-k. Of course, the context table can instead be updated by the processing module Pi-k.

If the context table contains no service data (context) corresponding to the application associated with the stream, the processing module Pi-k is preferably adapted to send the user, via the graphical interface Gli-k of his user equipment UEi-k, a message prompting him to supply said service data. The data can afterwards be integrated into the context table, where applicable after authorization by the user.

When a processing module Pi-k has determined the context (service data) associated with the application, it delivers to the control module CMi, which is installed in the satellite terminal STi to which the user equipment UEi-k from which the stream comes is connected, configuration data for configuring said satellite terminal STi. The configuration data is to enable the satellite terminal STi to make available to the stream to be transmitted resources suited to the quality of service and/or security requirements of the application with which it is associated.

The transmission of configuration data between a processing module Pi-k and a control module CMi is preferably effected in accordance with a communication protocol chosen from at least the SNMP, the XML protocol, and the RSVP or one of its extensions. However, a proprietary protocol could be used, of course.

Three illustrative and nonlimiting examples of exchanging configuration data are given hereinafter, respectively corresponding to the XML protocol, a proprietary protocol, and an extension of RSVP messages.

In the example of a protocol based on an XML code, an optimized mail function is used between the user agent Pi-k of the equipment UEi-k and the control agent CMi of the satellite terminal STI, relying on UDP sockets transporting XML structures.

The message containing the configuration data, as indicated hereinafter and sent by the user agent Pi-k to the satellite terminal STi, requests its control module CMi to provide a constant bit rate (CBR) quality of service (QoS) at 64 kbit/s for the IP stream in the direction from the satellite terminal STi to the satellite SAT and to secure transmission on the satellite link by using an IPSec ESP connection and a dynamic 128-bit key. The user agent Pi-k is identified by a session number (56) and the message is signed.

```
<?xml version=“1.0” encoding=“ISO-8859-1”?>
<UserSTProtocol Version= “1.0”>
  <SessionId>56</SessionId>
  <Command type= “SetQoS”>
    <SetQoS>
      <StreamDescription>
        <IPSrc>134.67.89.23</IPSrc>
        <IPDst>134.67.23.85</IPDsr>
        <PortSrc>6734</PortSrc>
        <PortDst>80</PortDsr>
      </StreamDescription>
      <QoS>
        <CBR>64000</CBR>
      </QoS>
      <Direction>In</Direction>
    </SetQoS>
  </Command>
  <Command type= “SetSecurity”>
    <SetSecurity>
      <StreamDescription>
        <IPSrc>134.67.89.23</IPSrc>
        <IPDst>134.67.23.85</IPDsr>
        <PortSrc>6734</PortSrc>
        <PortDst>80</PortDsr>
      </StreamDescription>
      <IPSec>
        <Algo>ESP</Algo>
        <Key type= “generated”>
        <KeyLength>128</KeyLength>
        </Key>
      </IPSec>
      <Direction>Bidirectional</Direction>
    </SetSecurity>
  </Command>
  <Signature> BE13 C061 DE4B CB99 7B5C 42EA 1F48 2997
  A35C D07B
</Signature>
</UserSTProtocol>
```

In the example of a protocol based on a proprietary mail system, an optimized mail function can be used between the user agent Pi-k of the user equipment UEi-k and the control agent CMi of the satellite terminal STi, relying on UDP sockets transporting C structures.

```
Enum CommandType {
  Unknown=0,
  MsgStatusOK=1,
  MsgStatusKO=2,
  SetQos=3,
  SetSecurity=4,
}
ProtocolDataUnit {
Uint16 Version = 1;
Uint32 sessionId = 56;
Uint32 msgId = 5;
Uint32 CommandType= SetQoSId;
SetQoS {
  Uint8 IpSrc[4]= 134.67.89.23;
  Uint8 IpDst[4]= 134.67.89.23;
  Uint16 PortSrc = 6734;
  Uint16 PortDst = 80;
  Uint32 CBR=64000;
  Uint32 VBR=0;
  Uint32 UBR=0;
  Uint32 Direction=in;
}
  Uint8 Signature[ ]=BE13 C061 DE4B CB99 7B5C 42EA 1F48
  2997 A35C
D073
}
ProtocolDataUnit {
Uint16 Version = 1;
Uint32 sessionId = 56;
Uint32 msgId = 6;
Uint32 CommandType= SetSecurity;
SetSecurity {
  Uint8 IpSrc[4]= 134.67.89.23;
  Uint8 IpDst[4]= 134.67.89.23;
  Uint16  PortSrc = 6734;
  Uint16  PortDst = 80;
    Uint32 Algo=ESP;
Uint32 KeyLength=128;
    Uint32 Key [128]= {0,...,0}// generated
}
  Uint8 Signature[ ]=BE13 C061 DE4B CB99 7B5C 42EA 1F48
  2997 A35C
D073
}
```

The third example is based on the RSVP, which is defined by the RFC 2205 standard. Its main benefit lies in its interaction with certain routers that can take into account or ignore the extensions, thereby enabling bandwidth reservation and end-to-end or section by section security.

Remember that IP streams are defined by the RFC 2210 standard and that the authentication of RSVP messages is defined by the RFC 2747 standard. Also, messages are transported here in the RSVP message extensions.

For example, in the case of configuration data representative of security, on the occasion of a PATH message, the satellite terminal STi adds to the private fields that encapsulate the payload data all of the information useful for identifying the data. Securing the satellite link therefore begins on receiving an RSVP RESV message.

For security at the IP level, the streams are already described, but the addresses of the satellite terminals STi can only be determined from information contained in an RSVP RESV packet. On the other hand, for Ethernet or satellite packet security at level two (2), source and destination labels or addresses can be added to the RSVP PATH packet and repeated in the RSVP RESV message.

For example, in the case of configuration data representative of the quality of service (QoS), QoS requests are updated in the RSVP PATH messages and applied on receiving the RSVP RESV message.

Mail optimization, resource reservation, and secure satellite link set-up can be effected using timers or semistatically (in the case of release on demand).

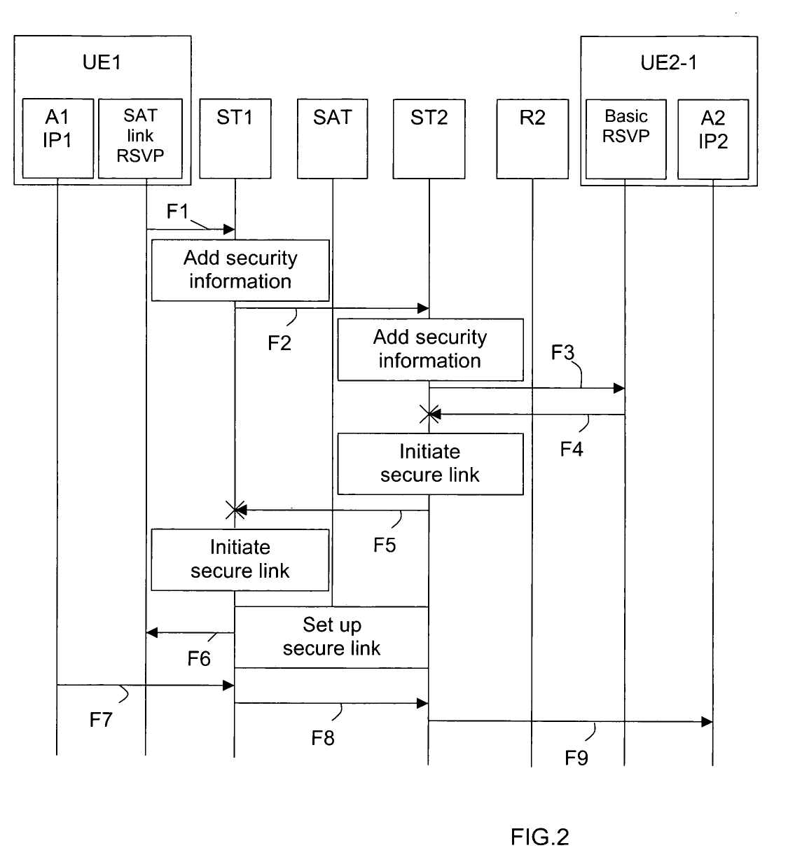

FIG. 2 shows an example of the use of RSVP messages to secure a satellite link.

In this example, the application Al running on the user equipment UE1 with Internet address IP1 sends data to the user equipment UE2 with Internet address IP2 using the Internet Protocol (IP). The application A1 is associated with the following process: “Secure the satellite link between the stations ST1 and ST2”. The data can start to be sent without security and secured during sending or blocked by the equipment UE1 until there is confirmation that the link is secure (as in the example shown).

The user equipment UE1 therefore constructs an RSVP PATH packet addressed to the user equipment UE2. The packet contains the description of the IP stream and extensions specifying the process to be applied to it. The packet is sent to the station ST1 in conformance with the IP routing protocol (arrow F1).

The station ST1 interprets the RSVP extensions of the PATH message and where applicable adds thereto information on its satellite address. It then has the message forwarded to the station ST2 using the satellite network (arrow F2).

The station ST2 interprets the RSVP extensions of the PATH message and where applicable adds thereto information on its satellite address. It then has the message forwarded to the user equipment UE2 (arrow F3).

The RSVP portion of the equipment UE2 interprets the RSVP PATH message and sends the station ST2 an RSVP RESV message that repeats the information from the PATH message (arrow F4).

The station ST2 interprets the RSVP extensions of the RESV message and initializes securing of the satellite link between the stations ST1 and ST2. It then has the message forwarded to the station ST1 (arrow F5).

The station ST1 interprets the RSVP extensions of the RESV message, adds thereto confirmation that the satellite link with the station ST2 is secure, and has the message forwarded to the user equipment UE1 (arrow F6).

The user equipment UE1 then receives the confirmation that the link is secure and can exchange data with the user equipment UE2 on the secure satellite link between the stations ST1 and ST2 (arrows F7, F8 and F9).

For example, the control module CMi-k configures the satellite medium access control (MAC) layer of one of the protocol stacks of the satellite terminal STi so that the process can be applied to the IP stream. To be more precise, this consists in prioritizing and/or encrypting within the satellite MAC layer the source and destination addresses and the source and destination ports.

The station ST can apply any process to streams. It can in particular prioritize certain streams, a QoS on certain streams, elimination of undesirable streams, encryption or signing of a stream, and so on.

Moreover, the streams can in particular be of IP, ATM, Ethernet, MPLS, satellite, application and like levels.

The control system according to the invention can not only control outgoing streams, as described above, but also control incoming streams and bidirectional streams.

To be more precise, each processing module Pi-k is preferably adapted to deliver to the control module CMi to which it is connected service data representative of the quality of service and/or the security associated with an application stream that must be received by the communication module Ci of the satellite terminal STi in which it is installed. In this way, the control module CMi can configure the satellite terminal STi so that it reserves for the incoming stream, which must soon reach a remote communication terminal ST, resources of a satellite link from the remote satellite terminal to itself, suited to the quality of service and/or security requirements of the application with which said incoming stream is associated.

In the case of a request for reservation of resources associated with a bidirectional link, the processing module Pi-k is preferably adapted to deliver to the control module CMi to which it is connected service data representative of the quality of service and/or security associated with outgoing and incoming application streams. In this way, the control module CMi can configure its satellite terminal STi so that it reserves, just as much for future outgoing streams as for future incoming streams, resources of a bidirectional satellite link suited to the quality of service and/or security requirements of the application with which said incoming and outgoing streams are associated.

Moreover, it is not obligatory for the action of the device on a stream of packets, for example IP packets, to relate to all the packets of the stream. In fact, it can be envisaged that the first packets of a stream are transmitted by the satellite terminal STi with no security and/or quality of service and that security and/or quality of service are instigated “on the fly” for subsequent packets. It is also possible to envisage a “blocking” mode of operation in which the first packets of a stream are set to wait until security and/or quality of service have been achieved (in other words, until the path is secure and/or the bandwidth has been reserved).

Moreover, it is possible to use Diffserv marking to distinguish streams at the level of a satellite terminal STi. The Diffserv protocol enables bits of the header of an IP stream to be used to specify the stream type. In this case, each extraction module Ei-k can preferably be adapted to impose that the IP packets observe at the level of the core Ni-k a Diffserv marking consistent with the requirements of the associated application and, of course, with the capacities of the satellite network. The processing module Pi-k must then inform the control module CMi that the Diffserv marking used is coherent and must be taken into account. In this case, the markings of the IP streams that are not of the same type are ignored and those IP streams are managed with the default quality of service.

It is important to note that a station's control module CMi can operate autonomously or in a distributed manner. In the latter case, it delivers its configuration data after it has received an authorization (or a confirmation) from a central server, such as a bandwidth broker or a network control center (NCC), or a key server responsible for distributing keys for securing links.

The control system, and to be more precise its processing module P, extraction module E, and control module C, and where applicable each memory M, con be implemented in the form of electronic circuits, software (data processing) modules, or a combination of circuits and software. The basic operation of the control system according to the invention can best be summarized by the example described below.

A user starts an FTP application installed in his user equipment UE1 in order to transfer (upload) a file to the server of his network. The FTP application then sends a first IP packet to set up a TCP link with said server.

The extraction module E1 installed in the user equipment UE1 detects the first IP pocket at the level of the core N1 of its user equipment UE1 and recovers all the information associated therewith (IP addresses, ports, FTP application references, name, icon, etc.) in order to identify the application. It then sends the processing module P1 to which it is connected a message designating the FTP application.

The processing module P1 then determines if there is service data (a context) associated with the FTP application in the context table of the memory M1. If this is not the case, for example, it opens a dialog window using the graphical interface Gl1 of the user equipment UE1 to request from the user the service data (context) that it wishes to associate with the FTP application. For example, the user requires a bit rote of 100 kbit/s and encryption of the call.

Once in possession of the context of the FTP application, the processing module P1 dialogs with the control module CM1 installed in the satellite terminal ST1 to supply it said context and enable it to configure the satellite MAC layer and to enable the satellite terminal ST1 to process the IP stream. The user can where applicable control the real incoming/outgoing bit rate of his user equipment UE1 and decide to modify the context associated with the IP stream of the FTP application.

The invention is not limited to the embodiments of a network, a communication station, a communication terminal, and a control system described hereinabove by way of example only, but encompasses all variants thereof within the scope of the following claims that the person skilled in the art might envisage.

Thus there has been described in the foregoing an application of the invention to satellite communication networks. However, the invention relates to all networks in which it is possible to associate at least one particular process with a data stream.

There is claimed:

1. A system for controlling processes associated with streams of application data for a communication network including communication stations adapted to exchange data streams and connected to communication terminals provided with at least one application and one core containing information representative of said applications, which system includes: i) processing means adapted, on receiving a message designating an application, to deliver service data representative of at least one process associated with said designated application, ii) extraction means adapted, on receiving a stream of data sent by a communication terminal, to access the core of said terminal to determine the application associated with said received stream and then to deliver to said processing means a message designating said determined application, and iii) control means adapted, on receiving service data delivered by said processing means, to deliver configuration data adapted to enable at least one process suited to the requirements of the application associated with the received stream by the communication station to which the terminal from which said stream come is connected.

2. The system claimed in claim 1 wherein each communication terminal core includes an interface for real time control of the network streams associated with said applications and said extraction means are adapted, on receiving a data stream, to access said control interface to determine the application associated with said received stream.

3. The system claimed in claim 1, further including memory means adapted to store a table of correspondences between said applications and said service data, and wherein said processing means are adapted, on receiving a message designating an application, to access said memory means to determine service data stored in correspondence with said designated application.

4. The system claimed in claim 3 wherein said processing means are adapted, in the absence in said memory means of service data stored in correspondence with a designated application, to send a user via a graphical interface of the communication terminal in which said extraction means are installed a message requesting said service data associated with the designated application.

5. The system claimed in claim 3 wherein said extraction means are adapted to update said correspondence table as a function of information received.

6. The system claimed in claim 5 wherein said updating information is contained in a configuration file received by the communication terminal in which said extraction means are installed.

7. The system claimed in claim 5 wherein said updating information is delivered by a graphical interface of the communication terminal in which said extraction means are installed.

8. The system claimed in claim 1 wherein said extraction means are installed in a protocol stack of a communication terminal core.

9. The system claimed in claim 1 wherein each communication station has at least one protocol stack arranged in layers, including an MAC layer, and said control means are adapted, on receiving service data, to deliver configuration data for configuring said MAC layer as a function of the requirements associated with a stream to be transmitted or received.

10. The system claimed in claim 1 wherein said processing means are adapted to deliver to said control means service data representative of at least one process associated with streams to be received from an application installed in a remote communication terminal.

11. The system claimed in claim 1 wherein said control means are adapted to deliver said configuration data on receiving an authorization delivered by a central server of said network.

12. The system claimed in claim 1 wherein said processing means and said control means are adapted to exchange service messages containing said service data in accordance with an exchange protocol chosen from among a proprietary protocol, the SNMP, the XML protocol, and the RSVP.

13. The system claimed in claim 1 wherein said process is chosen from a group including at least quality of service, encryption, authentication, session set-up, stream prioritization, and stream elimination.

14. A communication terminal including extraction means and processing means of a control system as claimed in any one of the preceding claims.

15. A communication terminal including a control system as claimed in any one of claims 1 to 13.

16. A communication station including control means of a control system as claimed in any one of claims 1 to 13.

17. The communication station claimed in claim 16, taking the form of a satellite terminal.

18. A communication network including a multiplicity of communication stations as claimed in either claim 16 or claim 17 and communication terminals as claimed in claim 14 or claim 15.

19. The communication network claimed in claim 18, chosen in a group including at least satellite networks and wireless networks.
